(19) United States
(12) Patent Application Publication
(10) Pub. No.: US 2008/0001520 A1
(43) Pub. Date: Jan. 3, 2008

(54) Field emission device having on chip anode discharge shunt elements

(76) Inventor: Scott V. Johnson, Scottsdale, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/479,795

(22) Filed: Jun. 30, 2006

(51) Int. Cl. H01J 63/04; H01J 1/62

(52) U.S. Cl. 313/495; 313/497; 313/496

(57) ABSTRACT

A field emission display (100, 200) is provided having an increased discharged time, a reduced or eliminated visible “flash”, reduced power loss associated with pulling down the anode voltage, and reduced parasitic losses and external circuitry. The field emission display (100, 200) includes a first substrate (106) including a cathode plate (110) comprising a plurality of active display devices (102) preferably a plurality of carbon nanotubes (114), a plurality of discharge emitter devices (103) preferably a plurality of carbon nanotubes (117), and dielectric surfaces (137, 138), wherein the plurality of active display devices (102) emit electrons (132) during a scanning mode, and the plurality of discharge emitter devices (103) and the plurality of active display devices (102) emit electrons (132) to strike the dielectric surfaces (137, 138) during a discharge mode. An anode plate (122) is positioned to receive the electrons (132) from the plurality of active display devices (102) during the scanning mode. A series electron emitter device (103) positioned on a second substrate (322) preferably including a plurality of carbon nanotubes (328) is coupled to the anode plate (122) for reducing the voltage on the anode plate (122) during the discharge mode.

### FIELD OF THE INVENTION

The present invention generally relates to field emission displays and more particularly to a field emission display having a reduced discharge time, a reduced or eliminated visible “flash”, reduced power loss associated with pulling down the anode voltage, and reduced parasitic losses and external circuitry.

### BACKGROUND OF THE INVENTION

Field emission displays are well known in the art. A field emission display includes an anode plate and a cathode plate that define a thin envelope. Typically, the anode plate and cathode plate are thin enough to necessitate some form of a spacer structure to prevent implosion of the device due to the pressure differential between the internal vacuum and external atmospheric pressure. The spacers are disposed within the active area of the device, which includes the electron emitters and phosphors.

The potential difference between the anode plate and the cathode plate is typically within a range of 300-10,000 volts. To withstand the potential difference between the anode plate and the cathode plate, the spacers typically include a dielectric material. Thus, the spacers have dielectric surfaces that are exposed to the evacuated interior of the device.

During the operation of the field emission display, electrons are emitted from the electron emitters, such as Spindt tips or carbon nanotubes for example, toward the anode plate. These electrons traverse the evacuated region and impinge upon phosphors positioned on the anode plate; however, some of these electrons may strike the dielectric surfaces of the spacers. In this manner, the dielectric surfaces of the spacers become charged. Typically, the dielectric spacers become positively charged because the secondary electron yield of the spacer material is initially greater than one.

Numerous problems arise due to the charging of the dielectric surfaces within a field emission display. For example, control over the trajectory of electrons adjacent to the spacers is lost. Also, the risk of electrical arcing events increases dramatically.

It is known to use electron current from the electron emitters coupled with a fixed resistance connected between the anode plate and an anode voltage source to reduce the voltage at the anode plate and cause the electrons to be attracted by the charged surfaces instead of the anode. The electrons are used to neutralize the charged surfaces. However, the electrons that bounce off of or emit secondarily from the dielectric surface also strike the phosphors, which results in a visible “flash” of light being generated at the viewing screen of the field emission display. Furthermore, the fixed resistance between the anode plate and the anode voltage source necessitates a high current to pull down the anode voltage, which results in large power losses. Conventionally, this discharge is accomplished every frame, resulting in a high current drain and a perceptive “buzz”.

U.S. Pat. No. 6,031,336 disclosed a pull-down circuit integrated on a substrate separate from the substrate containing electron emitters for illuminating the display screen. This patent taught a method of reducing charge accumulation in a field emission display, thereby reducing or eliminating a visible “flash” and reducing the power loss associated with pulling down the anode voltage. However, a series inductance and transconductance of a large area device impacts the discharge time. And parasitic losses and external circuitry increases cost of the field emission display.

Accordingly, it is desirable to provide a field emission display having a reduced discharged time, a reduced or eliminated visible “flash”, reduced power loss associated with pulling down the anode voltage, and reduced parasitic losses and external circuitry. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

An field emission device is provided having a reduced discharged time, a reduced or eliminated visible “flash”, reduced power loss associated with pulling down the anode voltage, and reduced parasitic losses and external circuitry. The apparatus includes a first substrate including a cathode plate comprising a plurality of active display devices (preferably a plurality of carbon nanotubes), a plurality of discharge emitter devices (preferably a plurality of carbon nanotubes), and dielectric surfaces, wherein the plurality of active display devices emit electrons during a scanning mode, and the plurality of discharge emitter devices and the plurality of active display devices emit electrons to strike the dielectric surfaces during a discharge mode. An anode is positioned to receive the electrons from the plurality of active display devices during the scanning mode. A series electron emitter device positioned on a second substrate (preferably including a plurality of carbon nanotubes) is coupled to the anode plate for reducing the voltage on the anode plate during the discharge mode

### BRIEF DESCRIPTION OF THE DRAWINGS

The present invention will hereinafter be described in conjunction with the following drawing figures, wherein like numerals denote like elements, and

FIG. 1 is a cross-sectional view of a field emission display in accordance with an exemplary embodiment;

FIG. 2 is a top view of an integrated circuit of the exemplary embodiment; and

FIG. 3 is a timing diagram illustrating a method for operating a field emission display in accordance with the exemplary embodiment.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A field emission display comprises an anode voltage pull-down circuit that discharges the anode for allowing emitted electrons from the device to discharge positively electrostatically charged surfaces within the display device. A portion of the anode voltage pull-down circuit, in accordance with an exemplary embodiment described herein, is positioned in the periphery of the cathode structure, which conventionally is an unused area of the cathode. This placement reduces parasitic losses and eliminates the need for external circuitry, thereby materially reducing cost. Additionally, the discharge time can be radically reduced by the lower series inductance and high transconductance of a large area device.

Preferably, the anode voltage pull-down circuit provides the benefit of reducing or eliminating an electron current that activates the phosphors during the step of reducing the anode voltage. This reduces power dissipation associated with reducing the anode voltage and provides the benefit of avoiding generation of an undesirable, visible “flash”. Due to the rapid discharge, the wave shape can be tailored to reduce audible noise. The anode voltage pull-down circuit is particularly useful for anode scanning potentials of greater than 600 volts, preferably greater than 1000 volts, and most preferably greater than 3000 volts.

The method for operating a field emission display in accordance with the invention includes the steps of reducing a potential at the anode and, thereafter, causing a discharge current to be emitted from the electron emitters of the display device. The discharge current is useful for neutralizing positively electrostaticly charged surfaces within the display device. This avoids generation of a visible “flash” from the display during the step of reducing the anode potential. Furthermore, the step of reducing the anode potential is preferably controlled in order to control the response of the display device and/or the anode power supply.

The placement of the anode voltage pull-down circuit in the periphery provides several advantages. Proximity of the anode voltage pull-down circuit to the display reduces parasitic inductance, allowing faster pull-down time. Very little additional cost is realized by the addition of the structure in the periphery of the display. The space that would be consumed by an external shunt discharge element is eliminated, and high voltage isolation/insulation is simplified.

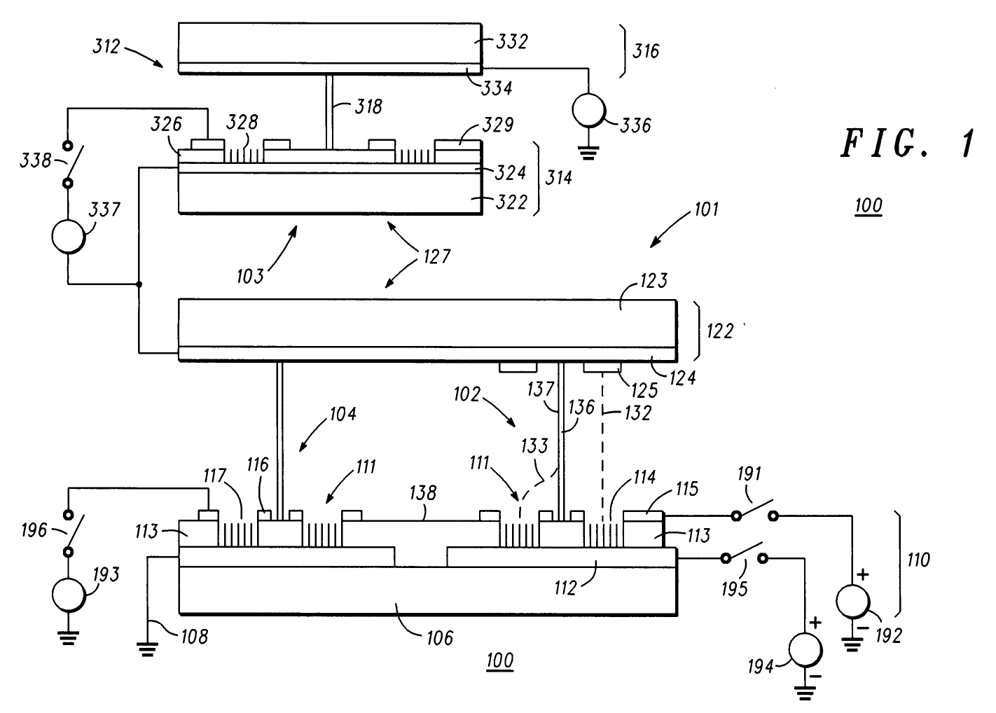

FIG. 1 is a cross-sectional view of a field emission display 100 in accordance with an exemplary embodiment. The field emission display 100 includes integrated circuits (chips) 101 and 103 (though an alternate embodiment may comprise only one integrated circuit). Integrated circuit 101 includes an active display device 102 and a discharge emitter device 104 integrated on the substrate 106. Integrated circuit 101 includes a cathode plate 110 and an anode plate 122 spaced apart by spacers 136. Cathode plate 110 includes the substrate 106, which can be made from glass, silicon, and the like. A plurality of conductive columns 112, integral to the active display device 102, is disposed upon substrate 106. A conductive material 108, integral to the discharge emitter device 104, is disposed on the substrate 106. A dielectric layer 113 is disposed upon conductive columns 112 and conductive material 108 and further defines a plurality of wells 111 in the active display device 102 and the discharge emitter device 104.

Electron emitters 114 are disposed in each of the wells 111 within the active display device 102 and electron emitters 117 are disposed in each of the wells 111 within the discharge emitter device 104. Anode plate 122 is disposed to receive an electron current 132 emitted by electron emitters 114 and 117. A plurality of conductive rows 115 (emitter gate) is formed on dielectric layer 113 proximate to the wells 111 within the active display device 102. Conductive columns 112 and conductive rows 115 are used to selectively address electron emitters 114 within the active display device 102. A conductive gate 116 is formed on the dielectric layer 113 proximate to the wells 111 within the discharge emitter device 104 for drawing electrons from emitters 117.

To facilitate understanding, FIG. 1 depicts only a few rows and one column within the active device 102. However, it is desired to be understood that any number of rows and columns may be employed. An exemplary number of rows for active display device 102 is 240, and an exemplary number of columns is 720. Methods for fabricating cathode plates for matrix-addressable field emission displays are known to one of ordinary skill in the art. Likewise, though only one emitter discharge device 104 is shown, it is desired to be understood that any number of emitter discharge devices 104 may be employed.

Anode plate 122 includes a transparent substrate 123 made from, for example, glass. An anode 124 is disposed on transparent substrate 123. Anode 124 is preferably made from a transparent conductive material, such as indium tin oxide. In the preferred embodiment, anode 124 is a continuous layer that opposes the entire emissive area of cathode plate 110. That is, anode 124 opposes the entirety of electron emitters 114 of the active display device 102 and electron emitters 117 the discharge emitter device 104. Anode 122 is designed to be coupled to a potential source 336, which is preferably a direct current (D.C.) voltage source, in a manner to be discussed hereinafter. A plurality of phosphors 125 is disposed upon anode 124 within the active display device 102. Methods for fabricating anode plates for matrix-addressable field emission displays are also known to one of ordinary skill in the art.

Spacers 136 are useful for maintaining a separation distance between cathode plate 110 and anode plate 122. Only two spacers 136 are depicted in FIG. 1. However, the actual number of spacers 136 depends on the structural requirements of the integrated circuit 101. Spacers 136 can be made from a dielectric material, a bulk resistive material, or a combination thereof. Spacers 136 can be thin plates, ribs, or any of numerous other shapes. Any dielectric surface defined by spacer 136 can become a positively electrostatically charged surface 137 during the operation of field emission display 100. Other surfaces, such as a surface 138 of dielectric layer 113, within display device 102 can also become positively electrostatically charged during operation of the device. These surfaces become charged because some of the electrons of electron current 132 impinge upon gas molecules that become positively ionized and impact these surfaces. If a surface has a secondary electron yield of greater than one, the surface emits more than one electron for each electron or ion received. Thus, a positive potential is developed. The method of the invention is useful for reducing the charge on these surfaces, while simultaneously improving power requirements, black level, and response of potential source 336 during the steps for reducing the charge.

A voltage source 194 is connected to each of conductive columns 112 by circuitry represented by switch 195. Voltage source 194 is useful for applying potentials, as defined by video data, for creating a display image and for reducing charge accumulation in display device 102. A voltage source 192 is connected to each of conductive rows 115 by circuitry represented by the switch 191. Voltage source 192 is useful for applying potentials for creating a display image and for reducing charge accumulation in active display device 102. Conductive material 108 is coupled to a low potential, for example, ground. Conductive gate 116 is coupled to a voltage source 193 by circuitry represented by switch 196 that is switched on during the discharge mode (in actuality, voltage source 193 may be the same as voltage source 192, but the voltage is applied to the conductive gate 116 only during the discharge mode).

The integrated circuit 103 includes a series electron emitter device 312 comprising a cathode plate 314 and an anode plate 316 spaced apart by a spacer 318. Cathode plate 314 includes a substrate 322, which can be made from glass, silicon, and the like. A conductive material 324 is disposed upon substrate 322. A dielectric layer 326 is disposed upon conductive material 324 and further defines a plurality of wells 327. An electron emitter 328 is disposed in each of the wells 327. The electron emitter may comprise for example a plurality of carbon nanotubes, but generally would comprise an emitter similar to the electron emitters 114. A plurality of conductive rows 329 (emitter gate) is formed on the dielectric layer 326 proximate to the wells 327 within the series electron emitter device 312 and is coupled to a voltage source 337 by circuitry represented by a switch 338. Conductive material 324 and the conductive rows 329 are used to address the electron emitters 328. Anode plate 316 is disposed to receive an electron current emitted by electron emitters 328. Anode plate 316 includes a transparent substrate 332 made from, for example, glass. An anode 334 is disposed on transparent substrate 332. Anode 334 is preferably made from a transparent conductive material, such as indium tin oxide. In the preferred embodiment, anode 334 is a continuous layer that opposes the entire emissive area of cathode plate 314. That is, anode 334 opposes the entirety of electron emitters 328. Anode 334 is designed to be selectively connected to a potential source 336, which is preferably a direct current (D.C.) voltage source. The conductive material 324 is electrically coupled to the anode plate 124.

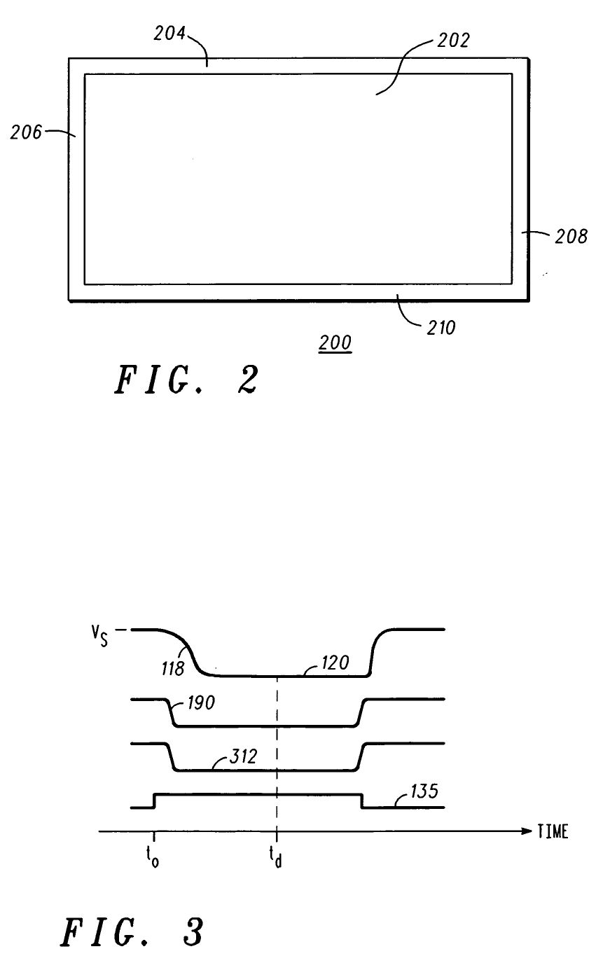

Referring to FIG. 2, and in accordance with the exemplary embodiment described herein, a top view of the integrated circuit 101 containing the active field emission display 102 and the discharge emitter device 104, without the anode plate 122 and spacers 136, comprises an active area 202 generally located in the center portion of the substrate. The active area 202 contains a matrix of pixels of the active display devices 102 that emit electrons to illuminate the anode 124. Column input/output interconnects 204 and row input/output interconnects 206 are positioned along two sides of the substrate for addressing the columns and rows of the pixels of active emitter devices 102. The other two sides 208 and 210 of the substrate contain the discharge emitter devices 104. In an alternate embodiment where the series electron emitter device 312 is fabricated on the same substrate as the display device 102 and the discharge emitter device 104, the series electron emitter device 312 and the portion of the anode receiving electrons therefrom are both electrically isolated from the substrate containing the display device 102 and the discharge emitter device 104 and the anode receiving electrons therefrom. Preferably, the series electron emitter device 312 would be positioned on the periphery of the integrated circuit 200 on one of sides 208 or 210 on a side of the discharge emitter devices 104 opposed to the active area 202.

The operation of field emission display 100, is characterized by two modes of operation: a scanning mode and a discharge mode. During the scanning mode, potentials are sequentially applied to conductive rows 115. By scanning it is meant that a potential suitable for causing electron emission is selectively applied to the scanned row. Whether each of electron emitters 114 within a scanned row is caused to emit electrons depends upon the video data and the voltage applied to each column. Electron emitters 114 in the rows not being scanned are not caused to emit electrons. During the time that one of conductive rows 115 is scanned, potentials are applied to conductive columns 112 according to video data.

During the scanning mode, an anode voltage 120, which is the potential at anode 124, is selected to attract electron current 132 toward anode plate 122 and to provide a desired level of brightness of the image generated by phosphors 125. Anode voltage 120 is provided by potential source 336. During the scanning mode, anode voltage 120 is held at some value, V_{S}, which is preferably greater than 600 volts, more preferably greater than 1000 volts, and most preferably greater than 3000 volts.

During the scanning mode, most of the electrons emitted by electron emitters 114 strike anode plate 122. However, some of the emitted electrons impinge upon dielectric surfaces such as emitter wall 137 and surface 138 within active display device 102, causing the dielectric surfaces to become positively electrostatically charged. The charged surfaces cause undesirable effects, such as adversely affecting the control of electron current 132.

To achieve the discharge mode of operation of field emission display 100, and in accordance with the exemplary embodiment, anode voltage 120 is reduced from a scanning mode value, V_{S}, to a discharge mode value, V_{D}, and electron current 133 is increased from a scanning mode value, I_{S}, to a discharge mode value, I_{D}. The discharge mode value, I_{D}, Of electron current 133 is useful for neutralizing positively electrostatically charged surfaces within display device 102. Anode voltage 120 is reduced by an amount sufficient to allow electron current 133 to be directed toward the charged surfaces. Preferably, anode voltage 120 is reduced to about ground potential. Anode voltage pull-down circuit 127 (including discharge emitter device 104 and series electron emitter device 312) is useful for reducing anode voltage 120 during the discharge mode of operation.

The discharge current, I_{D}, is preferably generated by causing the entirety of electron emitters 114 to emit electrons. This is achieved by applying the appropriate emission “on” potentials to all of rows 115, columns 112, and conductive material 108 of cathode plate 110. Thus, the discharge current available for neutralization is equal to the product of the total number of rows 115 and the maximum emission current per row 115, and the maximum emission current of conductive material 108. The discharge current can also be generated by causing less than all of electron emitters 114 to emit electrons.

In the preferred embodiment, the pull-down and discharge steps occur at the end of a display frame, subsequent to one scanning cycle. However, other suitable timing schemes can be employed. For example, the discharge mode can occur after multiple display frames have been executed.

FIG. 3 is a timing diagram illustrating a method for operating field emission display 100 of FIG. 1 in accordance with the exemplary embodiment. During the scanning mode configuration of anode voltage pull-down circuit 127 of the embodiment of FIG. 1, electron emitters 117 of discharge emitter device 104 and electron emitters 328 of series electron emitter device 312 do not emit. The control signal 135 triggers the voltage source 337 on and the voltage source 193 off during the scanning mode. A current 190 flows from cathode 324 to anode 124 to sustain anode voltage 120 for receiving electrons from electron emitters 114 during the scanning mode of operation of display device 102.

As further illustrated in FIG. 3, during the discharge mode configuration of anode voltage pull-down circuit 127, a control signal 135 is applied at time t₀ to voltage sources for activating electron currents. The control signal 135 triggers the voltage source 337 on and the voltage source 193 off, and when anode voltage 120 is reduced sufficiently, at time t_{d}, the discharge current is generated within display device 102, thereby causing the electron emitters 117 and 328 to emit electrons for discharging the spacers 136 and surfaces 138. Thereafter, the discharge current, I_{D}, is terminated, and anode voltage 120 is returned to its scanning mode value, V_{S}. The slope 118 of the signal 120 is improved over the previously known art by having a higher rate due to less distributed inductance because of the proximity of the shunt discharging circuitry (discharge emitter devices 104) to the display (active display devices 102).

In summary, the invention is for a field emission display having an anode voltage pull-down circuit connected to the anode of the field emission display. The anode voltage pull-down circuit has a discharge mode configuration, which is employed to reduce the potential at the anode. Preferably, the anode voltage pull-down circuit provides the benefit of reducing or eliminating activation of the phosphors during the step of reducing the anode voltage. The preferred method for operating a field emission display in accordance with the invention includes the steps of reducing a potential at the anode and, thereafter, causing a discharge current to be emitted from the electron emitters for neutralizing positively electrostatically charged surfaces within the field emission display. The field emission display and method of the invention provide numerous benefits, such as improved power requirements, improved black level of the display device, and improved control over the response of the anode power supply and of the display plates to a reduction in anode voltage.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A field emission device comprising:
a first substrate including a cathode plate comprising a plurality of active display devices, a plurality of discharge emitter devices, and dielectric surfaces, wherein the plurality of active display devices emit electrons during a scanning mode and the plurality of discharge emitter devices and the plurality of active display devices emit electrons to strike the dielectric surfaces during a discharge mode;
an anode positioned to receive the electrons from the plurality of active display devices during the scanning mode; and
a series electron emitter device coupled to the anode for reducing the voltage on the anode during the discharge mode.

2. The field emission device of claim 1 wherein the plurality of active display devices are positioned centrally within the first substrate and the plurality of discharge emitter devices are positioned on a periphery of the first substrate.

3. The field emission device of claim 1 further comprising a second substrate having the series electron emitter device positioned thereon.

4. The field emission device of claim 1 wherein both the plurality of active display devices and the plurality of discharge emitter devices each comprise a plurality of carbon nanotubes.

5. The field emission device of claim 1 wherein the series electron emitter device is positioned on the first substrate.

6. A field emission device comprising:
a plurality of electron emitter devices positioned on a first substrate; and
an anode pull down circuit comprising:
a plurality of emitter discharge devices positioned on the first substrate; and
at least one series electron emitter device;
an anode plate coupled to the at least one series electron emitter device and positioned to receive electrons from the plurality of electron emitter devices during a scanning mode; and
a plurality of spacers positioned to separate the electron emitter devices and the anode plate, the plurality of spacers receiving electrons emitted from the electron emitter devices and the plurality of emitter discharge devices during a discharge mode.

7. The field emission device of claim 6 wherein the plurality of electron emitter devices are positioned centrally within the first substrate and the plurality of emitter discharge devices are positioned on a periphery of the first substrate.

8. The field emission device of claim 6 further comprising a second substrate having the series electron emitter device positioned thereon.

9. The field emission device of claim 6 wherein both the plurality of electron emitter devices and the plurality of emitter discharge devices each comprise a plurality of carbon nanotubes.

10. The field emission device of claim 6 wherein the series electron emitter device is positioned on the first substrate.

11. A field emission device comprising:
a first substrate comprising:
a cathode plate comprising:
a first cathode adapted to be coupled to a first voltage;
a first plurality of electron emitters positioned on the first cathode; and
a first gate positioned near the first plurality of electron emitters and adapted to be coupled to a second voltage;
a second cathode adapted to be coupled to a third voltage;
a second plurality of electron emitters positioned on the second cathode; and
a second gate positioned near the second plurality of electron emitters and adapted to be coupled to a fourth voltage;
an anode plate positioned to receive electrons from the plurality of electron emitter devices during a scanning mode;
a plurality of spacers positioned between and separating the cathode plate and the anode plate, and positioned to receive electrons from the plurality of electron emitter devices and the second plurality of electron emitters during a discharge mode; and
an anode pull down circuit comprising at least one series electron emitter device coupled to the anode plate for reducing the voltage on the anode plate during the discharge mode.

12. The field emission device of claim 11 wherein the first plurality of electron emitters are positioned centrally within the first substrate and the second plurality of emitters are positioned on a periphery of the first substrate.

13. The field emission device of claim 11 further comprising a second substrate having the series electron emitter device positioned thereon.

14. The field emission device of claim 11 wherein both the first plurality of electron emitters and the second plurality of electron emitters each comprise a plurality of carbon nanotubes.

15. The field emission device of claim 11 wherein the series electron emitter device is positioned on the first substrate.
